(19) United States
(12) Patent Application Publication
(10) Pub. No.: US 2009/0052000 A1
(43) Pub. Date: Feb. 26, 2009

(54) IMAGE FORMING DEVICE

(75) Inventor: Hideyuki Sakata, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., Nagano-Shi (JP)

(21) Appl. No.: 12/192,389

(22) Filed: Aug. 15, 2008

(30) Foreign Application Priority Data
Aug. 17, 2007 (JP) 2007-212950

(51) Int. Cl. G02B 26/02

(52) U.S. Cl. 359/228

(57) ABSTRACT

There is provided an image forming device. The image forming device includes: a light source for emitting light; a liquid lens configured to allow a focal point of the liquid lens to be adjusted and which focuses the light on an imaging plane; and drive means for driving the liquid lens to scan the focal point. The drive means scans the focal point to scan the light on the imaging plane, thereby forming an image.

This application is based on and claims priority from Japanese Patent Application No. 2007-212950, filed on Aug. 17, 2007, the entire contents of which are incorporated by reference herein.

### BACKGROUND

1. Technical Field

The present disclosure relates to an image forming device, and more particularly to an image forming device that forms an image by scanning light emitted from a light source.

2. Related Art

As a display device for displaying an image, a cathode-ray (CRT) type had been used. In recent years, a liquid-crystal display (LCD) and a plasma display panel (PDP) are much used instead of the CRT.

However, since there is a limit to miniaturization on the LCD and the PDP, a display device of projector type (hereinafter called a “projector”), which can be easily miniaturized to a portable size, receives attention as a mobile-ready display device. The projector is a display device that displays an image in an enlarged size on a screen through projection. In the structure of the projector, a projector main unit does not include a screen and hence is advantageous in terms of ease of miniaturization and weight reduction.

FIG. 1 shows an example of a projector. In the illustrated projector, a laser beam emitted from a light source 1 is projected on a screen 6 after being scanned by means of polygon mirrors 2, 3 assigned respectively to an X-direction scan and a Y-direction scan. In this case, a galvanometer mirror may be used in place of the polygon mirrors (see e.g., JP-A-2-221995).

However, when a polygon mirror or a galvanometer mirror is employed, these mirrors must be accurately aligned along two directions (the direction X and the direction Y) orthogonal to each other. Thus, there is a problem in that manufacturing cost increases resultant from complication of a structure of the display device. Moreover, the projector must be equipped with two mirrors to be driven, there is a problem in that miniaturization of the projector is difficult.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

According to one or more aspects of the present invention, an image forming device includes: a light source for emitting light; a liquid lens configured to allow a focal point of the liquid lens to be adjusted and which focuses the light on an imaging plane; and drive means for driving the liquid lens to scan the focal point, wherein the drive means scans the focal point to scan the light on the imaging plane, thereby forming an image.

According to one or more aspects of the present invention, the drive means includes: a plurality of electrodes provided on the liquid lens; and voltage control means for individually applying voltages to the plurality of electrodes.

According to one or more aspects of the present invention, the voltage control means includes: a horizontal voltage control section that applies voltages to the electrodes to scan the light in a horizontal direction; a vertical voltage control section that applies voltages to the electrodes to scan the light in a vertical direction; and a main control section that controls the horizontal voltage control section and the vertical voltage control section.

According to one or more aspects of the present invention, the plurality of electrodes are concentrically arranged.

According to one or more aspects of the present invention, the plurality of electrodes are concentrically arranged in a plurality of rows.

According to one or more aspects of the present invention, the plurality of electrodes are arranged in a matrix pattern.

According to one or more aspects of the present invention, the liquid lens comprises: a first liquid lens adapted to scan the focal point in a horizontal direction; and a second liquid lens adapted to scan the focal point to be adjusted in a vertical direction.

According to one or more aspects of the present invention, the light source is a laser light source.

According to one or more aspects of the present invention, a method of scanning light includes: a) applying the light to a liquid lens; b) driving the liquid lens to scan a focal point of the liquid lens; and c) scanning the light on an imaging plane to form an image.

Other aspects and advantages of the present invention will be apparent from the following description, the drawings, and the claims.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a schematic view showing an example of an image forming device in the related art;

FIG. 2 is a schematic view of an image forming device according to an exemplary embodiment of the present invention;

FIGS. 3A and 3B are views showing a liquid lens used in the image forming device according to an exemplary embodiment of the present invention, where FIG. 3A is a plan view of the liquid lens and FIG. 3B is a cross-sectional view of the liquid lens taken along line A-A in FIG. 3A;

FIG. 4 is a schematic view to describe electrodes provided in the image forming device according to an exemplary embodiment of the present invention;

FIGS. 5A to 5C are view showing a liquid lens in a state where a focal point is positioned at the center position, where FIG. 5A is a plan view of the liquid lens, FIG. 5B is a cross-sectional view of the liquid lens, FIG. 5C is a bottom view of the liquid lens in a state where voltages are applied to the liquid lens, and FIG. 5D is a view to describe applied voltage distributions in the drawings;

FIGS. 6A to 6C are views showing the liquid lens in a state where the focal point is displaced from the center position, where FIG. 6A is a plan view of the liquid lens, FIG. 6B is a cross-sectional view of the liquid lens, and FIG. 6C is a bottom view of the liquid lens in a state where voltages are applied to the liquid lens;

FIG. 7 is a view to describe scanning of a focal point of the liquid lens, where FIGS. 7(A) to (G) show the focal point of the liquid lens and FIG. 7(H) shows the focal point P on the screen;

FIG. 8 is a view showing a liquid lens using a matrix electrode as the electrode;

FIG. 9 is a view showing a liquid lens using a transparent electrode as the electrode; and

FIG. 10 is a view showing the configuration of an image forming device that is a modification of the image forming device shown in FIG. 2.

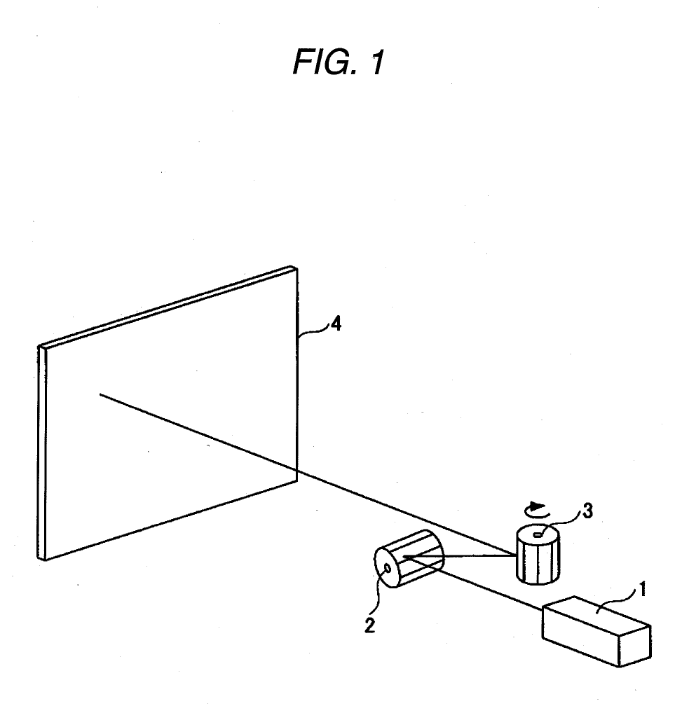

### DETAILED DESCRIPTION OF EXEMPLARY EMBODIMENTS OF THE PRESENT INVENTION

Exemplary embodiments of the present invention will be described with reference to the drawings hereinafter.

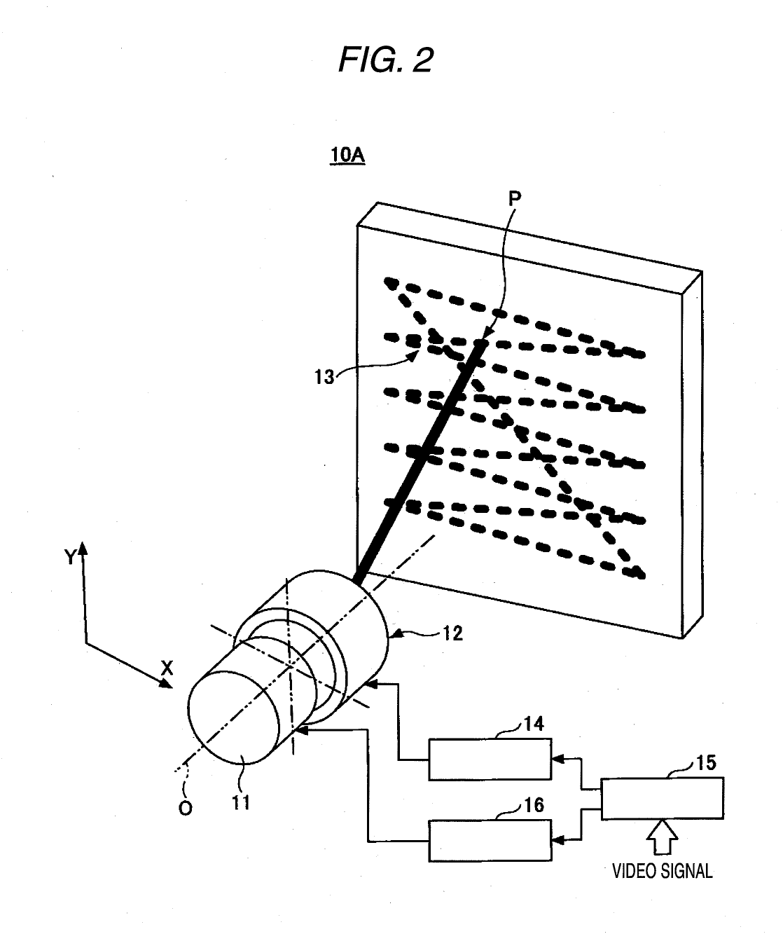

FIG. 2 is a block diagram of an image forming device 10A according to an exemplary embodiment of the present invention. In the exemplary embodiment, an example in which the image forming device 10A is applied to a display device of a projector type will be described. The image forming device 10A includes a laser light source 11, a liquid lens 12, a screen 13 and a lens drive unit 14, for example.

The laser light source 11 is a light source, e.g., a laser diode and emits a laser beam used for forming an image. The laser light source 11 is connected to a light source drive 16 that is controlled by an image formation controller 15. The image formation controller 15 generates image information based on an input video signal and controls the light source drive 16 based on the generated image information. The laser light source 11 emits a laser beam including the image information toward the screen 13 (an image surface).

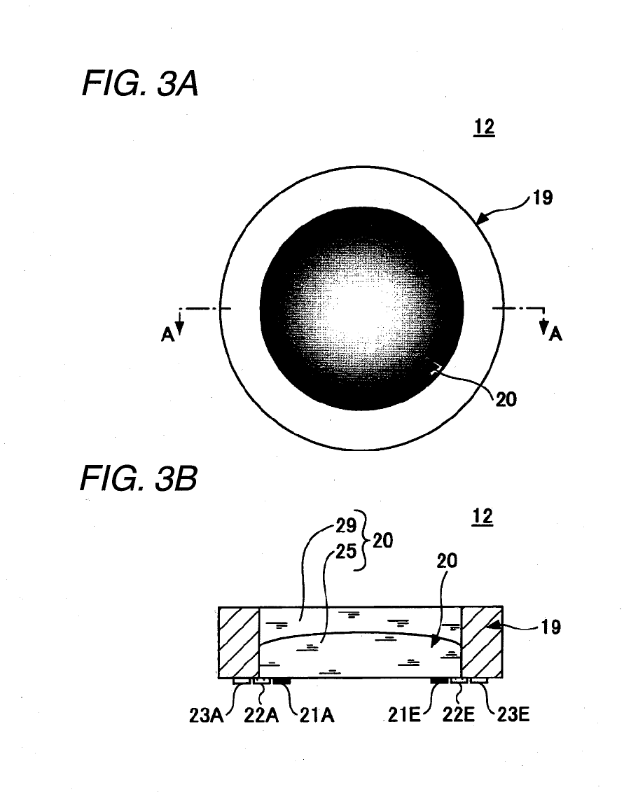

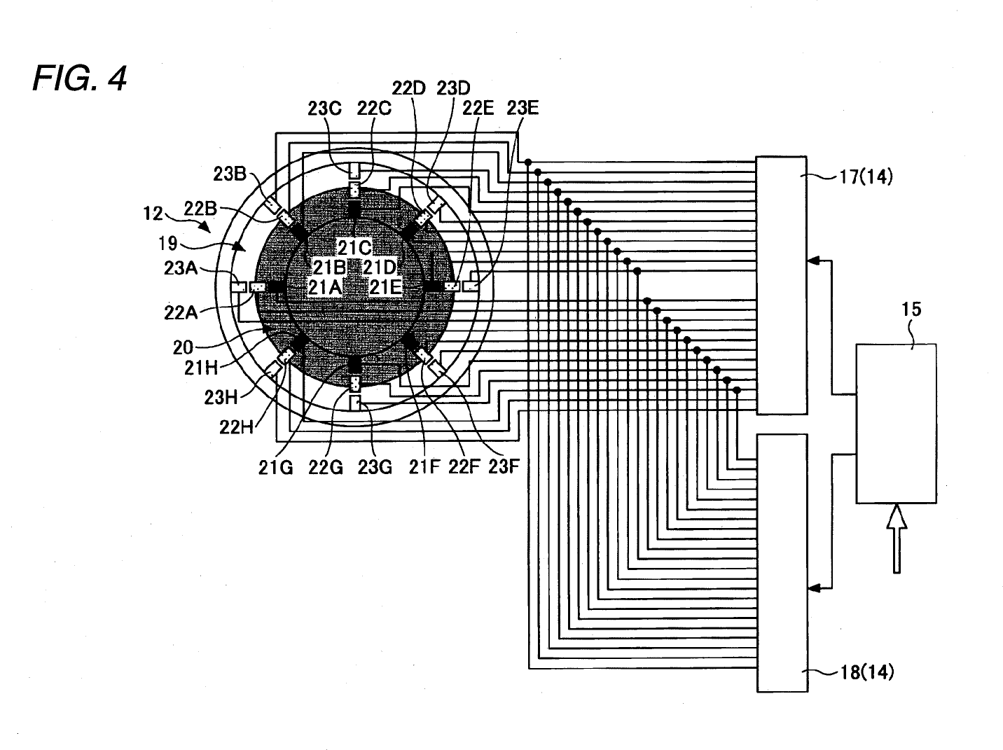

As shown in FIGS. 3A, 3B and 4, the liquid lens 12 includes a housing 19, a lens formation liquid 20 and electrodes 21A to 21H, 22A to 22H, 23A to 23H, for example. The lens formation liquid 20 is deformed by a voltage applied to the electrodes 21A to 21H, 22A to 22H, and 23A to 23H, whereby the liquid lens 12 exhibits a characteristic of changing a refractive index of light.

The housing 19 is a cylindrical member and made of an insulating material. The lens formation liquid 20 is provided in the housing 19.

The lens formation liquid 20 includes a first (aqueous) liquid 29 and a second (oil-based) liquid 25 each having different characteristics. When an uniform voltage is applied to the electrodes 21A to 21H, 22A to 22H, and 23A to 23H, the first liquid 29 and the second liquid 25 are uniformly present within the housing 19 (this state will be hereinafter referred to as a “reference state”).

However, upon applying the voltage to the electrodes 21A to 21H, 22A to 22H, and 23A to 23H, the first liquid 29 is displaced so as to come close to the electrodes 21A to 21H, 22A to 22H, and 23A to 23H in accordance with the intensity of the applied voltage. The second liquid 25 is thereby displaced to be pushed by the first liquid, to thus induce a change in the shape of the lens formation liquid 20. As a result, the refractive index and the focal point P are changed.

In the meantime, in the exemplary embodiment, eight electrodes 21A to 21H disposed along the innermost circumference; eight electrodes 22A to 22H disposed in the center circumference; and eight electrodes 23A to 23H disposed along the outermost circumference are provided as electrodes. Therefore, the electrodes are configured such that the electrodes 21A to 21H, the electrodes 22A to 22H, and the electrodes 23A to 23H are concentrically arranged in a plurality of rows. The respective electrodes 21A to 21H, 22A to 22H, and 23A to 23H are formed on a bottom surface of the liquid lens 12 in a circular pattern. Further, the electrodes are arranged at positions close to the outer circumference except the center where the light from the laser light source 11 enters.

The eight electrodes 21A to 21H are disposed at equal intervals of 45°, and the electrodes 22A to 22H and the electrodes 23A to 23H are also disposed at equal intervals of 45°. Moreover, a set of the electrodes 21A, 22A, and 23A is arranged in a row along a radial direction of the housing 19. Similarly, a set of the electrodes 21B, 22B, and 23B to a set of the electrodes 21H, 22H, and 23H are also arranged in a row along the radial direction.

The respective electrodes 21A to 21H, 22A to 22H, and 23A to 23H are connected to the lens drive 14. The lens drive 14 is configured so as to control voltages individually applied to the respective electrodes 21A to 21H, 22A to 22H, and 23A to 23H.

The lens drive 14 includes a horizontal voltage controller 17 and a vertical voltage controller 18 as shown in FIG. 4. The respective electrodes 21A to 21H, 22A to 22H, and 23A to 23H are connected to both the horizontal and vertical voltage controllers 17 and 18. Moreover, the horizontal voltage controller 17 and the vertical voltage controller 18 are connected to the image formation controller 15 and configured so as to control voltage individually applied to the respective electrodes 21A to 21H, 22A to 22H, and 23A to 23H based on an image control signal from the image formation controller 15.

A video signal inputted to the image formation controller 15 includes a horizontal sync signal and a vertical sync signal. The image formation controller 15 controls the horizontal voltage controller 17 based on the horizontal sync signal and also controls the vertical voltage controller 18 based on the vertical sync signal.

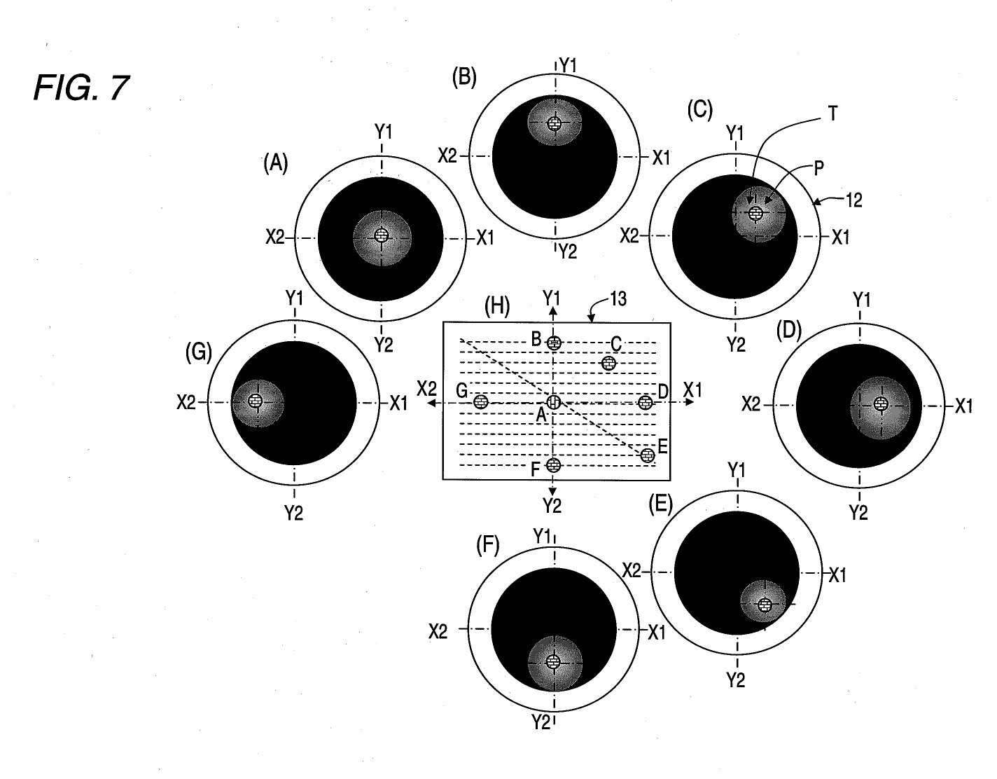

Accordingly, voltages corresponding to the horizontal sync signal and the vertical sync signal are applied to the respective electrodes 21A to 21H, 22A to 22H, and 23A to 23H. Specifically, the focal point P formed by the liquid lens 12 moves in a direction toward arrows X1 and X2 by driving the horizontal voltage controller 17. Further, the focal point P formed by the liquid lens 12 moves in a direction toward arrows Y1 and Y2 by driving the vertical voltage controller 18 (see FIGS. 7A to 7H).

As an example, specific specifications of the liquid lens 12 used in the present embodiment are described below.

Outer Dimension: 10.5 mm (diameter)×2.5 mm (thickness)

### Focal Length: 5 cm to ∞

Transmissivity of wavelengths of 400 to 700 nm: 80 to 90%

### Operating Frequency: 1 kHz

Power Consumption: Less than 1 Mw
Time required for inducing a change in the shape of a boundary surface: a maximum of 0.1 sec.

### Range of Operating Temperature: −25° C. to +60° C.

Guaranteed Number of Operations: Million operations

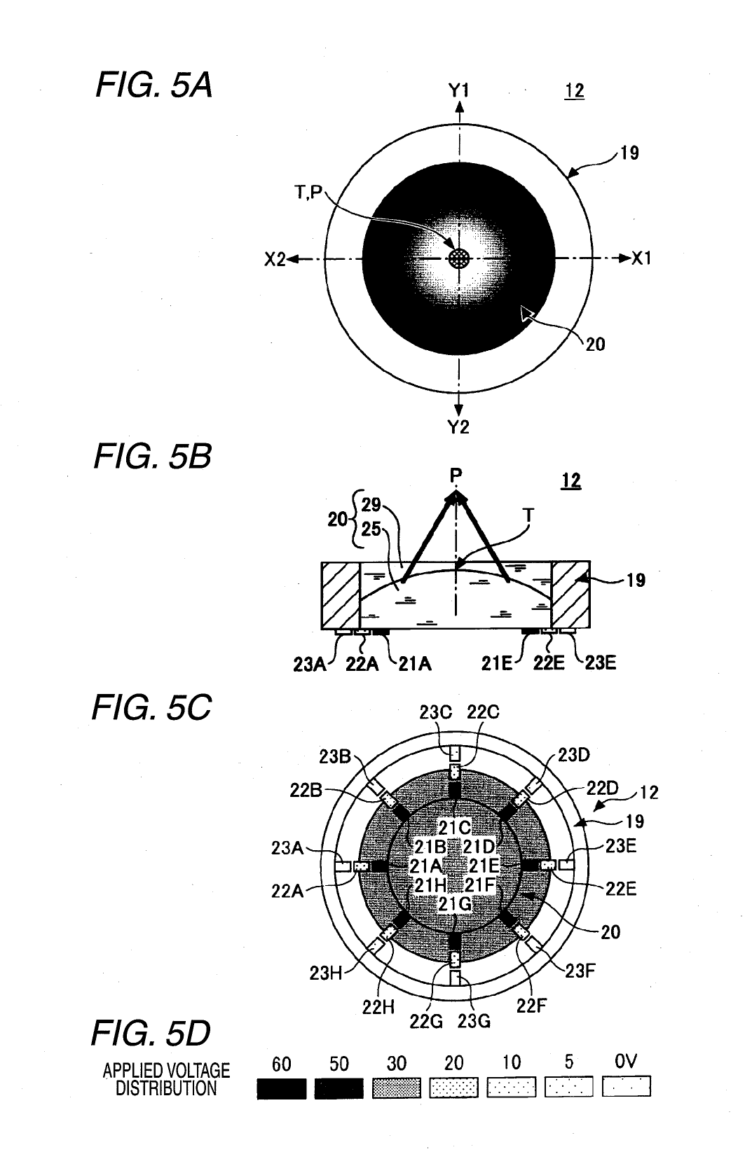

Subsequently, operation of the liquid lens 12 controlled by the lens drive 14 and the image formation controller 15 will be described with reference to FIGS. 5 through 7.

In FIGS. 5 through 7, levels of the voltages applied to the respective electrodes 21A to 21H, 22A to 22H, and 23A to 23H are indicated by densities of satins assigned to the electrodes 21A to 21H, 22A to 22H, and 23A to 23H. When the applied voltages are at a low level as shown in FIG. 5D, the satins are represented in a light color. When the applied voltages are at a high level, the satins are represented in a dense color.

FIGS. 5A to 5C show a state where an uniform voltage V1 is applied to the electrodes 21A to 21H, an uniform voltage V2 is applied to the electrodes 22A to 22H, and an uniform voltage V3 is applied to the electrodes 23A to 23H. The respective voltages are set so as to satisfy a relationship of V1>V2>V3. Specific values of the voltages V1, V2, and V3 are; for instance, V1=60V, V2=30V, and V3=0V.

As described above, the uniform voltages V1, V2, and V3 are applied to the electrodes 21A to 21H, 22A to 22H, and 23A to 23H arrange in a circular pattern, respectively, whereby the liquid lens 12 enters a state (a reference state) where uniform voltages balanced in directions X1 and X2 and directions Y1 and Y2 are applied.

In the reference state, the first liquid 29 and the second liquid 25 constituting the lens formation liquid 20 are uniformly present in the housing 19. Specifically, the first liquid 29 and the second liquid 25 are symmetrical shapes with respect to the center position (i.e., a cross-point of the direction X1-X2 and the direction Y1-Y2) of the lens formation liquid 20, and a center portion of the lens formation liquid 20 becomes convex upwardly as shown in FIG. 5B, thereby constituting a convex lens.

In the reference state, the focal point P coincides with an apex T of an interfacial shape. Further, the focal point P coincides with a center axis O (equal to the center axis of the housing 19) of the liquid lens 12. The apex T of the interfacial shape is defined by the highest position projecting from the bottom of the liquid lens 12 in a surface geometry of the lens formation liquid 20 deformed by applying voltages.

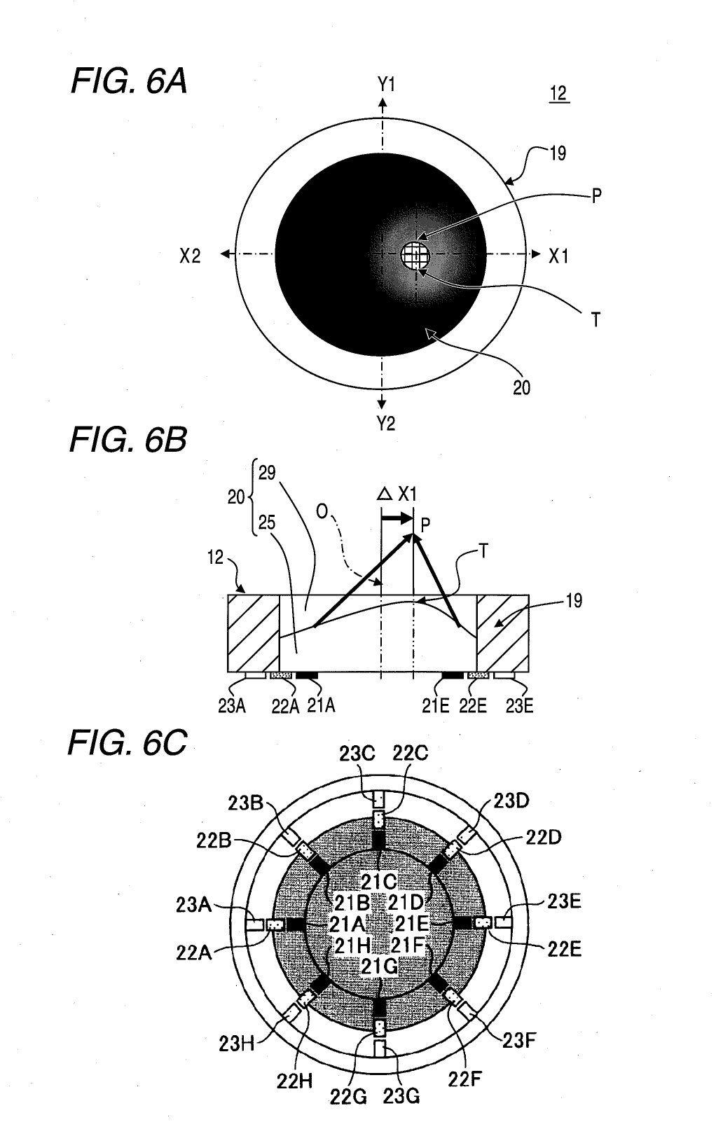

FIGS. 6A to 6C show states where nonuniform voltages are respectively applied to the electrodes 21A to 21H, electrodes 22A to 22H, and electrodes 23A to 23H. In the figures, when a voltage V4 is applied to the electrodes 21A, 21B, and 21H, a voltage V5 (V4≠V5) is applied to the electrodes 21C to 21G. Similarly, when a voltage V6 is applied to the electrodes 22A, 22B, and 22H, a voltage V7 (V6≠V7) is applied to the electrodes 22C to 22G. In the figures, an uniform voltage V8 is applied to the electrodes 23A to 23H located in the outermost circumference. Specific voltage values are; for instance, V4=10V, V5=60V, V6=5V, V7=30V, and V8=0V.

When uneven, unbalanced voltages are applied to the electrodes 21A to 21H and the electrodes 22A to 22H as described above, the lens formation liquid 20 is deformed, and the apex T of the interfacial shape is displaced from the center axis O of the liquid lens 12. Also, as shown in FIG. 6B, the apex T of the interfacial shape is displaced from the center axis O of the liquid lens 12 in the direction X1 by an amount of ΔX1. Similarly, the focal point P is also displaced from the center axis O of the liquid lens 12 in the direction of arrow X1 (see directions X1 and X2 in FIG. 6A). As described above, the focal point P and the apex T of the interfacial shape can be changed with respect to the center axis O of the liquid lens 12 by adjusting the voltages applied to the electrodes 21A to 21H, 22A to 22H, and 23A to 23H.

FIGS. 7(A) to (H) are views to describe scanning of the focal point P of the liquid lens 12 when the liquid lens 12 is applied to the image forming device 10A of a projector type. In the drawings, FIGS. 7(A) to (G) show the focal point of the liquid lens, and FIG. 7(H) shows the focal point P of the laser beam on the screen 13.

In order to facilitate comprehension, the respective liquid lenses 12 corresponding to respective focal points on the screen 13 designated by reference symbols A to G are shown as Figs. (A) to (G).

FIG. 7(A) shows the liquid lens 12 in the reference state, and the laser beam emitted from the laser light source 11 forms an image at the center position (the position designated by symbol A in FIG. 7(H)) of the screen 13 in the reference state.

As described above, the electrodes 21A to 21H, 22A to 22H, and 23A to 23H provided for the liquid lens 12 are connected to the horizontal voltage controller 17 (see FIG. 4). When voltages are applied in the reference state to the respective electrodes 21A to 21H, 22A to 22H, and 23A to 23H of the liquid lens 12 such that the focal point P moves in the direction of arrow X1, the focal point P moves from the reference position in the direction X1 as shown in FIG. 7(D). Thus, the laser beam emitted from the laser light source 11 forms an image at a position on the screen 13 designated by symbol D.

In the meantime, when the voltages are applied in the reference state to the respective electrodes 21A to 21H, 22A to 22H, and 23A to 23H of the liquid lens 12 such that the focal point P moves in the direction of arrow X2, the focal point P moves from the reference position in the direction X2 as shown in FIG. 7G. Therefore, the laser beam emitted from the laser light source 11 forms an image at a position on the screen 13 designated by symbol G. Consequently, the horizontal voltage controller 17 controls the voltages applied to the electrodes 21A to 21H, 22A to 22H, and 23A to 23H, thereby enabling scanning of the focal point P in the horizontal direction (the directions X1 and X2).

The electrodes 21A to 21H, 22A to 22H, and 23A to 23H provided for the liquid lens 12 are connected to the vertical voltage controller 18 (see FIG. 4). When voltages are applied in the reference state to the respective electrodes 21A to 21H, 22A to 22H, and 23A to 23H of the liquid lens 12 such that the focal point P moves in the direction of arrow Y1, the focal point P moves from the reference position in the direction Y1 as shown in FIG. 7B. Thus, the laser beam emitted from the laser light source 11 forms an image at a position on the screen 13 designated by symbol B.

In the meantime, when the voltages are applied in the reference state to the respective electrodes 21A to 21H, 22A to 22H, and 23A to 23H of the liquid lens 12 such that the focal point P moves in the direction of arrow Y2, the focal point P moves from the reference position in the direction Y2 as shown in FIG. 7(F). Therefore, the laser beam emitted from the laser light source 11 forms an image at a position on the screen 13 designated by symbol G. Consequently, the vertical voltage controller 18 controls the voltages applied to the electrodes 21A to 21H, 22A to 22H and 23A to 23H, thereby enabling scanning of the focal point P in the vertical direction (the directions Y1 and Y2).

Using the horizontal voltage controller 17 and the vertical voltage controller 18, voltages for controlling a horizontal scan and voltages for controlling a vertical scan are simultaneously applied to the electrodes 21A to 21H, 22A to 22H, and 23A to 23H. Thus, the liquid lens 12 can move the focal point P of the laser beam emitted from the laser light source 11 to perform scanning over the screen 13 in both the vertical and horizontal directions, and the laser beam can be focused at any position on the screen 13. Specifically, the focal point P can be adjusted at the position designated by symbol C or E in FIG. 7(H).

Using the horizontal and vertical voltage controllers 17 and 18, the liquid lens 12 is controlled and driven based on the vertical and horizontal synchronous signals included in a video signal inputted to the image formation controller 15. Further, the focal point P is scanned in synchronism with the vertical sync signal and the horizontal sync signal and the image information is superposed on the laser beam emitted from the laser light source 11. Therefore, an image corresponding to the video signal can be formed on the screen 13.

As described above, the image forming device 10A according to the present embodiment is configured to perform scanning of the laser beam from the laser light source 11 over the screen 13 using the liquid lens 12. As a result, when compared with the related-art structure in which a laser beam is caused to perform scanning using polygon mirrors or galvanometer mirrors, the structure of the present invention can be simplified, and fine adjustment for positioning mirrors is not required. Therefore, assembly of the image forming device 10A can be eased, and thus cost reduction can be achieved.

As described above, the image forming device 10A does not require providing comparatively-large components, such as galvanometer mirrors or polygon mirrors. Hence, miniaturization and weight reduction of the image forming device 10A become feasible. Moreover, since the liquid lens 12 does not require any mechanical operation when driven, an attempt can be made to achieve silence and a reduction in power consumption.

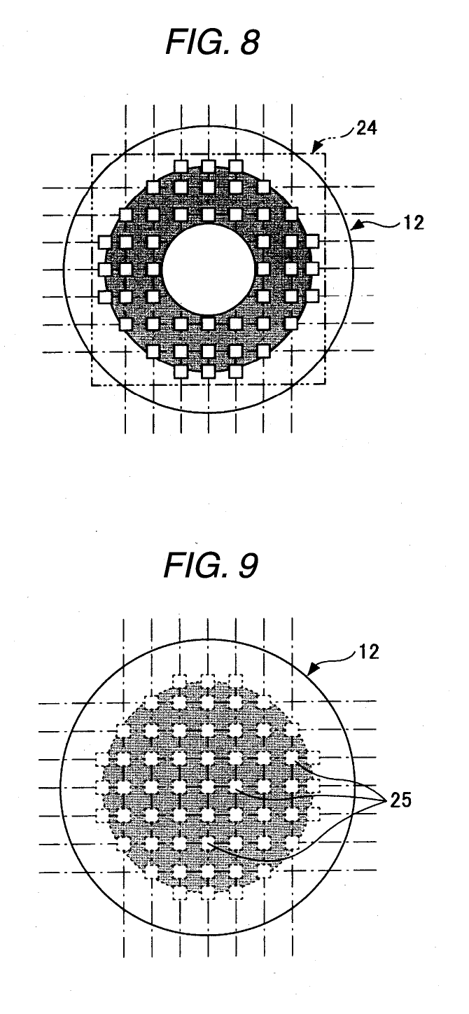

FIGS. 8 and 9 show another example of arrangement of the electrodes. In the above embodiment, the electrodes 21A to 21H, 22A to 22H, and 23A to 23H are concentrically arranged at uniform intervals of 45°, and are arranged to extend radially. In contrast, in an exemplary embodiment shown in FIG. 8, a matrix-shaped electrode 24 is used as the electrodes. With this configuration, the setting accuracy of the focal point P of the liquid lens 12 can be enhanced.

In an exemplary embodiment shown in FIG. 9, the electrodes are arranged in a matrix pattern, and transparent electrodes 25 are used as the respective electrodes. With this configuration, it can be prevented that laser beam emitted from the laser light source 11 is blocked by the electrodes, and quality of an image formed on the screen 13 can be enhanced. Further, when compared with the configuration shown in FIG. 8, selectivity of the focal point can be improved.

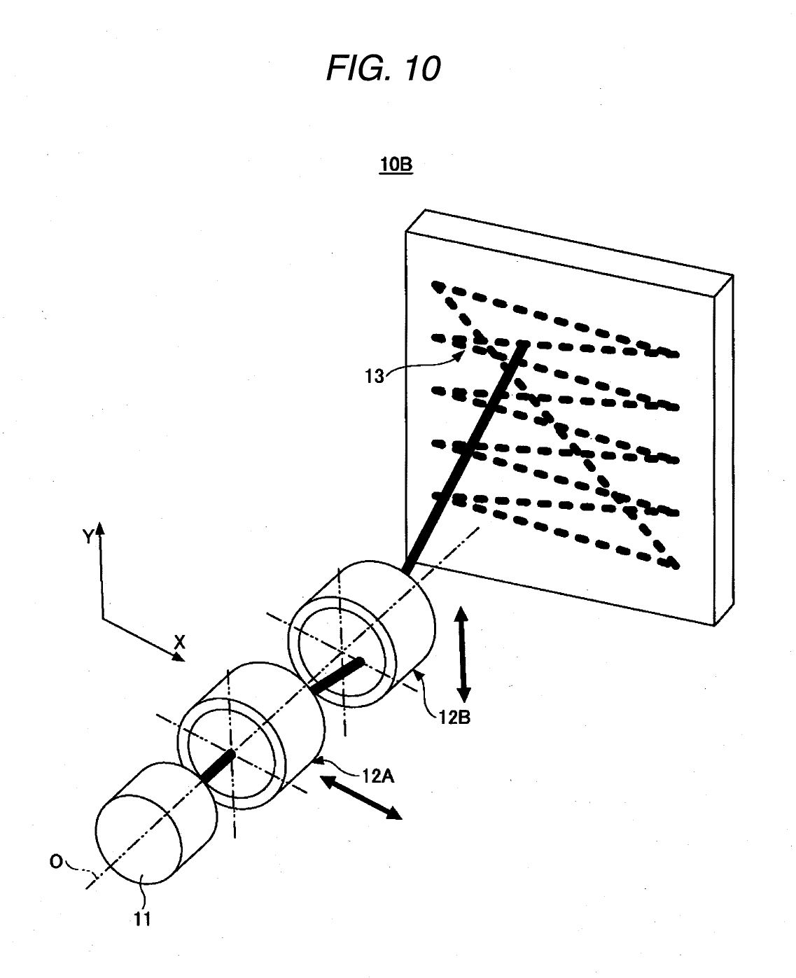

FIG. 10 is a schematic view showing an image forming device 10B according to a modification of the image forming device 10A shown in FIG. 2. In the image forming device 10A, as described above, the laser beam emitted from the laser light source 11 is scanned using the single liquid lens 12 in both the horizontal direction (the direction X) and the vertical direction (the direction Y).

Meanwhile, according to the image forming device 10B, two liquid lenses; namely, a horizontal liquid lens 12A and a vertical liquid lens 12B are used. The horizontal liquid lens 12A is connected to the horizontal voltage controller 17 and exhibits the function of causing the laser beam emitted from the laser light source 11 to perform scanning in the horizontal direction (the direction X). Further, the vertical liquid lens 12B is connected to the vertical voltage controller 18 and exhibits the function of causing the laser beam emitted from the laser light source 11 to perform scanning in the vertical direction (the direction Y).

As described above, the vertical scan and the horizontal scan are performed separately using the horizontal liquid lens 12A and the vertical liquid lens 12B, whereby highly-accurate scanning can be performed, and quality of an image formed on the screen 13 can be enhanced further.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. An image forming device, comprising:
a light source for emitting light;
a liquid lens configured to allow a focal point of the liquid lens to be adjusted and which focuses the light on an imaging plane; and
drive means for driving the liquid lens to scan the focal point,
wherein the drive means scans the focal point to scan the light on the imaging plane, thereby forming an image.

2. The image forming device according to claim 1, wherein the drive means comprises:
a plurality of electrodes provided on the liquid lens; and
voltage control means for individually applying voltages to the plurality of electrodes.

3. The image forming device according to claim 2, wherein the voltage control means comprises:
a horizontal voltage control section that applies voltages to the electrodes to scan the light in a horizontal direction;
a vertical voltage control section that applies voltages to the electrodes to scan the light in a vertical direction; and
a main control section that controls the horizontal voltage control section and the vertical voltage control section.

4. The image forming device according to claim 1, wherein the plurality of electrodes are concentrically arranged.

5. The image forming device according to claim 4, wherein the plurality of electrodes are concentrically arranged in a plurality of rows.

6. The image forming device according to claim 1, wherein the plurality of electrodes are arranged in a matrix pattern.

7. The image forming device according to claim 1, wherein the liquid lens comprises:
a first liquid lens adapted to scan the focal point in a horizontal direction; and
a second liquid lens adapted to scan the focal point to be adjusted in a vertical direction.

8. The image forming device according to claim 1, wherein the light source is a laser light source.

9. The image forming device according to claim 1, wherein the electrodes are transparent electrodes.

10. A method of scanning light, the method comprising:
a) applying the light to a liquid lens;
b) driving the liquid lens to scan a focal point of the liquid lens; and
c) scanning the light on an imaging plane to form an image.
